(19) United States
(12) Patent Application Publication
(10) Pub. No.: US 2024/0128541 A1
(43) Pub. Date: Apr. 18, 2024

(54) HEAT TRANSFER PLATES IN ELECTROCHEMICAL CELL SYSTEMS, AND METHODS OF PRODUCING THE SAME

(71) Applicant: 24M Technologies, Inc., Cambrige, MA (US)

(72) Inventor: Khosrow NEMATOLLAHI, Carmel, IN (US)

(21) Appl. No.: 18/380,830

(22) Filed: Oct. 17, 2023

Related U.S. Application Data
(60) Provisional application No. 63/416,774, filed on Oct. 17, 2022.

(51) Int. Cl. H01M 10/6555; H01M 10/6551; H01M 10/6562

(52) U.S. Cl. CPC H01M 10/6555; H01M 10/6551; H01M 10/6562

(57) ABSTRACT

Embodiments described herein relate to heat transfer plates with dimples for removal of heat from electrochemical cell systems. In some aspects, an electrochemical cell system can include a first electrochemical cell, a second electrochemical cell, a first planar sheet contacting the first electrochemical cell, the first planar sheet including a first plurality of dimples, and a second planar sheet contacting the second electrochemical cell, the second planar sheet extending parallel to the first planar sheet, the second planar sheet separated from the first planar sheet by a separation distance, the second planar sheet including a second plurality of dimples, wherein the first plurality of dimples and the second plurality of dimples are both configured to induce turbulence in an air stream flowing parallel to the first planar sheet and the second planar sheet.

### CROSS-REFERENCE TO RELATED APPLICATIONS

This application claims the benefit of U.S. Provisional Application No. 63/416,774, titled “Heat Transfer Plates in Electrochemical Cell Systems, and Methods of Producing the Same,” and filed Oct. 17, 2022, the content of which is incorporated herein by reference in its entirety.

### TECHNICAL FIELD

Embodiments described herein relate to heat transfer in electrochemical cell systems.

### BACKGROUND

Heat generation in electrochemical cells is a safety issue that can have dangerous results. Thermal runaway can lead to fires and thermal decomposition of the electrochemical cell materials. Passing streams of air or other gases along the surfaces of electrochemical cells can draw heat away from the electrochemical cells, similar to how fans are applied to processors in computers. However, heat transfer is limited in situations where the gas flows in the laminar flow regime. Turbulizing the gas stream can improve the heat transfer properties of the gas.

### SUMMARY

Embodiments described herein relate to heat transfer plates with dimples for removal of heat from electrochemical cell systems. In some aspects, an electrochemical cell system can include a first electrochemical cell, a second electrochemical cell, a first planar sheet contacting the first electrochemical cell, the first planar sheet including a first plurality of dimples, and a second planar sheet contacting the second electrochemical cell, the second planar sheet extending parallel to the first planar sheet, the second planar sheet separated from the first planar sheet by a separation distance, the second planar sheet including a second plurality of dimples, wherein the first plurality of dimples and the second plurality of dimples are both configured to induce turbulence in an air stream flowing parallel to the first planar sheet and the second planar sheet.

### BRIEF DESCRIPTION OF THE DRAWINGS

FIG. 1 is a block diagram of an electrochemical cell system, according to an embodiment.

FIGS. 2A-2H show illustrations of an electrochemical cell system and various components thereof, according to an embodiment.

FIGS. 3A-3C show a heat transfer plate, according to an embodiment.

FIGS. 4A-4D show a heat transfer plate, according to an embodiment.

FIG. 5 is a heat transfer coefficient map of airflow in the presence of a heat transfer plate with diamond-shaped dimples.

FIG. 6 is a heat transfer coefficient map of airflow in the presence of a heat transfer plate with contoured dimples.

FIGS. 7A-7B show negative space between heat transfer plates with teardrop-shaped dimples and an associated heat transfer coefficient map of airflow in the presence of the heat transfer plates.

FIGS. 8A-8B show negative space between heat transfer plates with rounded tetrahedron-shaped dimples and associated mesh and the heat transfer coefficient maps of airflow in the presence of the heat transfer plates.

FIGS. 9A-9B show negative space between heat transfer plates with rounded tetrahedron-shaped dimples and associated mesh and heat transfer coefficient maps of airflow in the presence of the heat transfer plates.

### DETAILED DESCRIPTION

Embodiments described herein relate to electrochemical cell systems with heat transfer mechanisms, and methods of producing the same. Systems and arrays of electrochemical cells can be arranged with lanes or pathways between the electrochemical cells for the flow of gas (e.g., air) or any other form of fluid. The gas flows by the arrays of electrochemical cells and draws heat away from the electrochemical cells, maintaining temperature within the electrochemical cell system and preventing thermal runaway. Unless significant energy is applied to dispensing the gas streams, the gas streams flow in the laminar flow regime between the electrochemical cells. Heat transfer has a direct relationship with Reynolds number. Therefore, if the gas flow becomes turbulent, the amount of heat transferred away from the electrochemical cells and into the gas can increase. The addition of plates with dimples near the electrochemical cells can aid in turbulizing the gas flow and improving heat transfer.

Dimples described herein can improve heat exchange properties of electrochemical cell systems. These dimples can spin the gas flow with high velocity along the x, y, and/or z axes in the local coordinates of the system. The dimples are geometrically designed to generate high 3-dimensional turbulence. Dimple shapes can be in a tetrahedral form, such that a base triangle and a top triangle have different areas to make all side edges inclined and at different angles of inclination. The dimples can be shaped to maximize heat transfer film coefficients.

Dimples described herein can be implemented in very thick and large cells (VT cells), batteries, battery packs, cold plates, energy storage systems, and/or mobile power grids (MPG's). Dimples described herein can be designed for integration with flow rate equalizer technologies (FRE) for systems as small as individual electrochemical cells. MPG's can also implement turbulizer technology and FRE for cells, modules, batteries, battery packs racks, high voltage units, and energy storage systems.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

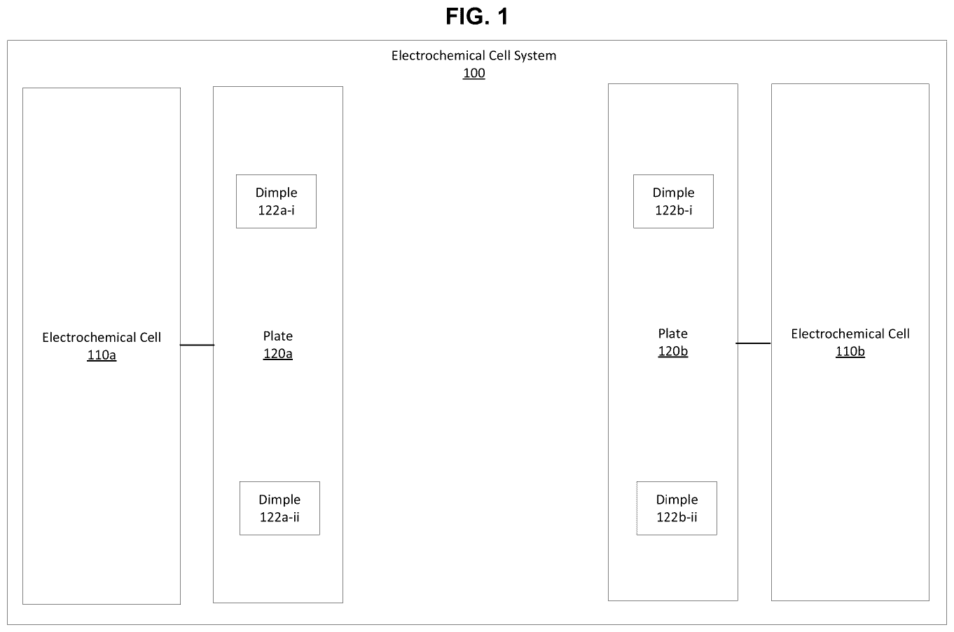

FIG. 1 is a block diagram of an electrochemical cell system 100, according to an embodiment. As shown, the electrochemical cell system 100 includes a first electrochemical cell 110a, a second electrochemical cell 110b (collectively referred to as electrochemical cells 110), a heat transfer plate 120a coupled to electrochemical cell 110a and a heat transfer plate 120b coupled to the electrochemical system 110b. In some embodiments, the electrochemical cell system 100 may also include a casing to encapsulate the assembly (i.e., the electrochemical cells 110, the heat transfer plates 120a, 120b). The heat transfer plate 120a includes dimples 122a-i and dimples 122a-ii whereas the heat transfer plate 120b includes dimples 122b-i and 122b-ii.

In some embodiments, the electrochemical cells 110 can be the same or substantially similar to the electrochemical cells described in U.S. Pat. No. 10,181,587 (“the '587 patent”), titled “Single Pouch Battery Cells and Methods of Manufacture,” filed Jun. 17, 2016, the disclosure of which is hereby incorporated by reference in its entirety. Each of the electrochemical cells 110 can include an anode material disposed on an anode current collector, a cathode material disposed on a cathode current collector, and a separator disposed between the anode material and the cathode material. The separator can be large enough that a portion of the separator extends beyond an outer edge of the anode material and an outer edge of the cathode material. The electrochemical cells 110 can further include a pouch material at least partially encasing the anode material, the anode current collector, the cathode material, the cathode current collector, and the separator. In some embodiments, the pouch material can contact the anode current collector, the cathode current collector, and/or the separator. The pouch material can be large enough that a portion of the pouch material extends beyond an outer bound of the separator. In order to minimize unused space in the electrochemical cell module, the pouch material and the separator can be folded relative to the anode material and the cathode material, rather than extending outward from the anode material and the cathode material.

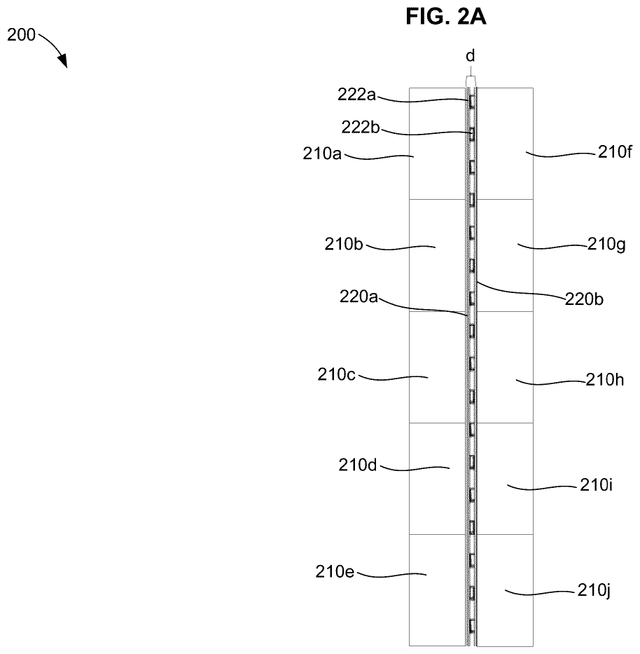

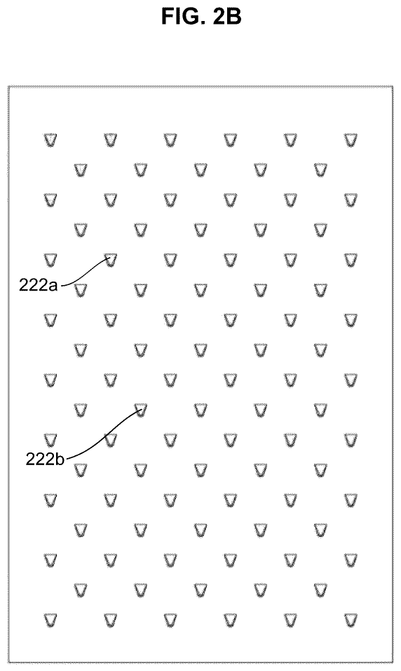

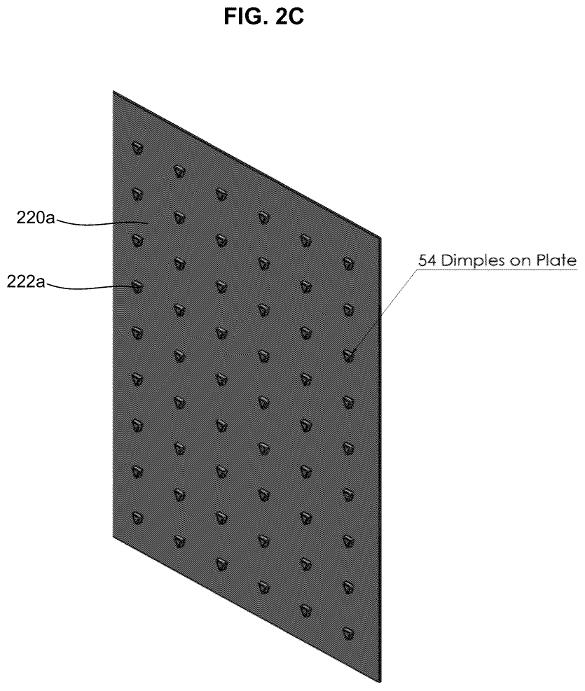

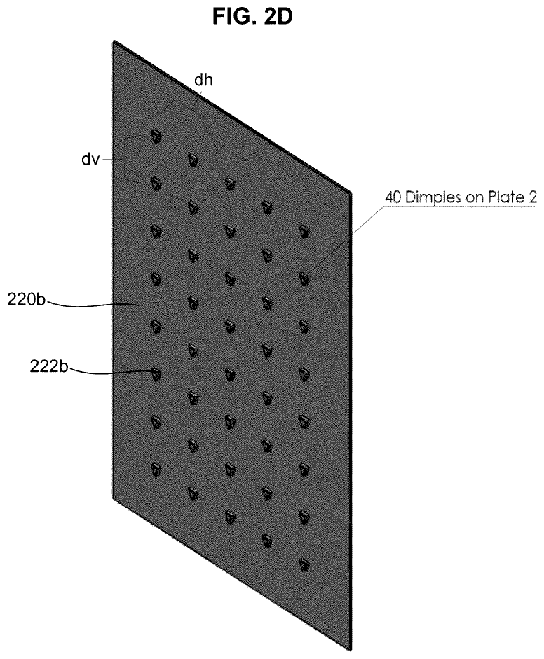

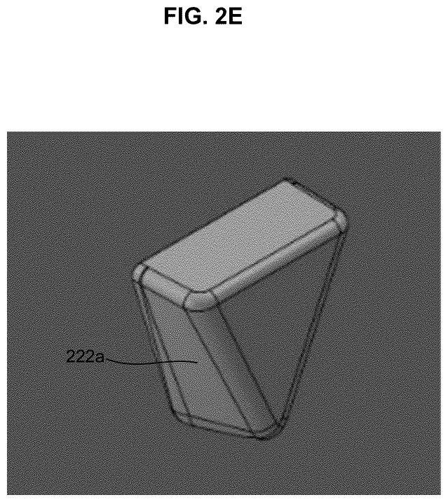

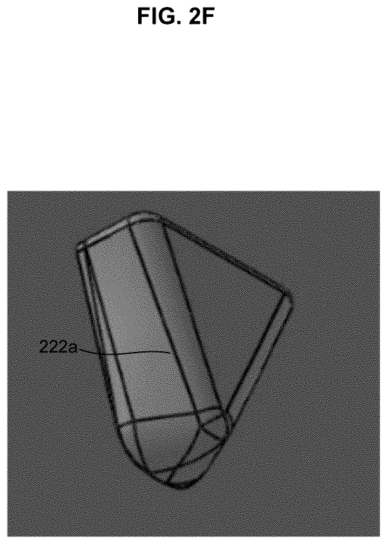

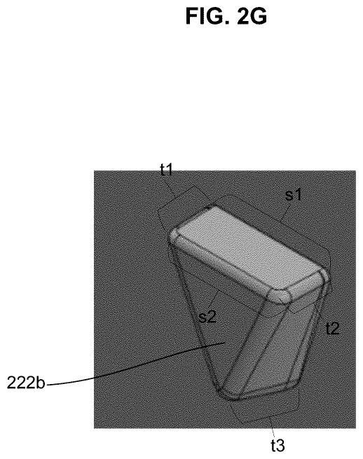

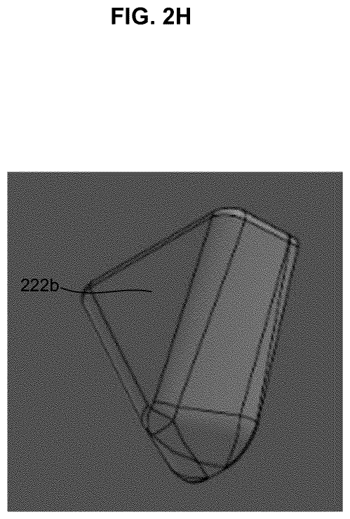

FIGS. 2A-2H show illustrations of an electrochemical cell system 200 and various components thereof, according to an embodiment. FIG. 2A shows an illustration of a cross section of the electrochemical system 200 including an array of electrochemical cells 210a, 210b, 210c, 210d, 210e, 210f, 210g, 210h, 210i, 210j (collectively referred to as electrochemical cells 210), heat transfer plates 220a and 220b including dimples 222a and 222b on surface of heat transfer plates 220a and 220b respectively. In some embodiments, the electrochemical cells 210, the heat transfer plates 220a, 220b, and the dimples 222a, 222b can be the same or substantially similar to the electrochemical cells 110, the heat transfer plates 120a, 120b, and the dimples 122a-i, 122a-ii, 122b-i, 122b-ii described above with reference to FIG. 1. Thus, certain aspects of the electrochemical cells 210, the heat transfer plates 220a, 220b, and the dimples 222a, 222b are not described in greater detail herein.

The heat transfer plate 220a is coupled to an array of electrochemical cells 210a, 210b, 210c, 210d, 210e, while the heat transfer plate 220b is coupled to an array of electrochemical cells 210f, 210g, 210h, 210i, 210j. Heat generated during operation of electrochemical cells 210a, 210b, 210c, 210d, 210e, and 210f, 210g, 210h, 210i, 210j is transferred to the heat transfer plates 220a and 220b, respectively via conduction, convection, and/or radiation. The heat transfer plates 220a and 220b are placed in closed proximity facing each other such that a channel is formed between them. In some embodiments air can flow through the channel between the heat transfer plates 220a, 220b to dissipate the heat. In some embodiments, the heat transfer plates may dissipate the heat through convection, radiation, or a combination thereof.

As shown, the heat transfer plate 220a and the heat transfer plate 220b are separated by a distance d. In some embodiments, d can be at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, d can be no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm. Combinations of the above-referenced values of d are also possible (e.g., at least about 100 μm and no more than about 10 cm or at least about 1 mm and no more than about 1 cm), inclusive of all values and ranges therebetween. In some embodiments, d can be about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the electrochemical cells 210 can be oriented with the anode and the cathode extending parallel or approximately parallel to the heat transfer plates 220a, 220b. In some embodiments, the electrochemical cells 210 can be oriented with the anode and the cathode extending perpendicular to the heat transfer plates 220a, 220b. In some embodiments, the heat transfer plates 220a, 220b can have a thickness of at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the heat transfer plates 220a, 220b can have a thickness of no more than about 10 mm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced thicknesses of the heat transfer plates 220a, 220b are also possible (e.g., at least about 100 μm and no more than about 10 mm or at least about 500 μm and no more than about 5 mm), inclusive of all values and ranges therebetween. In some embodiments, the heat transfer plates 220a, 220b can have a thickness of about 50 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, or about 10 mm.

In some embodiments the heat dissipation from the heat transfer plates 220a and 220b may occur via a heat transfer fluid other than air. In some embodiments the heat transfer fluid may include a liquid. In some embodiments, the heat transfer fluid can include an inert gas. In some embodiments, the heat transfer fluid can include air, nitrogen, argon, helium, or any combination thereof. In some embodiments, the heat transfer fluid can include an organic liquid. In some embodiments, the heat transfer fluid can include a liquid that is not reactive with lithium.

In some embodiments the volumetric flow rate of fluid flow in the channel between the heat transfer plates 220a, 220b can be at least about 0.01 cm³/min, at least about 0.05 cm³/min, at least about 0.1 cm³/min, at least about 0.5 cm³/min, at least about 1 cm³/min, at least about 5 cm³/min, at least about 10 cm³/min, at least about 50 cm³/min, at least about 100 cm³/min, at least about 500 cm³/min, at least about 1,000 cm³/min, at least about 5,000 cm³/min, at least about 10,000 cm³/min, at least about 50,000 cm³/min, at least about 100,000 cm³/min, at least about 500,000 cm³/min, at least about 1,000,000 cm³/min, at least about 5,000,000 cm³/min, at least about 10,000,000 cm³/min, at least about 50,000,000 cm³/min, or at least about 60,000,000 cm³/min. In some embodiments, the volumetric flow rate of fluid flow in the channel between the heat transfer plates 220a, 220b can be no more than about 60,000,000 cm³/min, no more than about 10,000 cm³/min, no more than about 5,000 cm³/min, no more than about 1,000 cm³/min, no more than about 500 cm³/min, no more than about 100 cm³/min, no more than about 50 cm³/min, no more than about 10 cm³/min, no more than about 5 cm³/min, no more than about 1 cm³/min, no more than about 0.5 cm³/min, no more than about 0.1 cm³/min, or no more than about 0.05 cm³/min. Combinations of the above-referenced volumetric flow rates are also possible (e.g., at least about 0.01 cm³/min and no more than about 10,000 cm³/min or at least about 1 cm³/min and no more than about 500 cm³/min), inclusive of all values and ranges therebetween. In some embodiments the volumetric flow rate of fluid flow in the channel between the heat transfer plates 220a, 220b can be about 0.01 cm³/min, about 0.05 cm³/min, about 0.1 cm³/min, about 0.5 cm³/min, about 1 cm³/min, about 5 cm³/min, about 10 cm³/min, about 50 cm³/min, about 100 cm³/min, about 500 cm³/min, about 1,000 cm³/min, about 5,000 cm³/min, about 10,000 cm³/min, about 50,000 cm³/min, about 100,000 cm³/min, about 500,000 cm³/min, about 1,000,000 cm³/min, about 5,000,000 cm³/min, about 10,000,000 cm³/min, about 50,000,000 cm³/min, or about 60,000,000 cm³/min.

In some embodiments, the electrochemical cells 210 can be arranged in rows and columns on either side of the channel. In some embodiments, the electrochemical cells can be arranged in arrays of p rows by q columns with a channel extending between each column and heat transfer plates positioned on either side of each channel. In some embodiments, p and/or q can be about 2, about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, about 50, about 55, about 60, about 65, about 70, about 75, about 80, about 85, about 90, about 95, or about 100, inclusive of all values and ranges therebetween. In some embodiments, the electrochemical cell system 200 can include an array of dividers (not shown) that partition the flow of the heat transfer fluid between different banks of the electrochemical cells 210. The dividers can be positioned such that equal or approximately equal amounts of heat transfer fluid flow through each channel.

In some embodiments, the average velocity of fluid flow in the channel between the heat transfer plates 220a, 220b can be at least about 0.1 m/s, at least about 0.2 m/s, at least about 0.3 m/s, at least about 0.4 m/s, at least about 0.5 m/s, at least about 0.6 m/s, at least about 0.7 m/s, at least about 0.8 m/s, at least about 0.9 m/s, at least about 1 m/s, at least about 2 m/s, at least about 3 m/s, at least about 4 m/s, at least about 5 m/s, at least about 6 m/s, at least about 7 m/s, at least about 8 m/s, at least about 9 m/s, at least about 10 m/s, at least about 20 m/s, at least about 30 m/s, at least about 40 m/s, at least about 50 m/s, at least about 60 m/s, at least about 70 m/s, at least about 80 m/s, or at least about 90 m/s. In some embodiments, the average velocity of fluid flow in the channel between the heat transfer plates 220a, 220b can be no more than about 100 m/s, no more than about 90 m/s, no more than about 80 m/s, no more than about 70 m/s, no more than about 60 m/s, no more than about 50 m/s, no more than about 40 m/s, no more than about 30 m/s, no more than about 20 m/s, no more than about 10 m/s, no more than about 9 m/s, no more than about 8 m/s, no more than about 7 m/s, no more than about 6 m/s, no more than about 5 m/s, no more than about 4 m/s, no more than about 3 m/s, no more than about 2 m/s, no more than about 1 m/s, no more than about 0.9 m/s, no more than about 0.8 m/s, no more than about 0.7 m/s, no more than about 0.6 m/s, no more than about 0.5 m/s, no more than about 0.4 m/s, no more than about 0.3 m/s, or no more than about 0.2 m/s. Combinations of the above-referenced average velocities are also possible (e.g., at least about 0.1 m/s and no more than about 100 m/s or at least about 1 m/s and no more than about 10 m/s), inclusive of all values and ranges therebetween. In some embodiments, the average velocity of fluid flow in the channel between the heat transfer plates 220a, 220b can be about 0.1 m/s, about 0.2 m/s, about 0.3 m/s, about 0.4 m/s, about 0.5 m/s, about 0.6 m/s, about 0.7 m/s, about 0.8 m/s, about 0.9 m/s, about 1 m/s, about 2 m/s, about 3 m/s, about 4 m/s, about 5 m/s, about 6 m/s, about 7 m/s, about 8 m/s, about 9 m/s, about 10 m/s, about 20 m/s, about 30 m/s, about 40 m/s, about 50 m/s, about 60 m/s, about 70 m/s, about 80 m/s, about 90 m/s, or about 100 m/s.

The heat transfer plates 220a, 220b include arrays of dimples 222a, 222b (collectively referred to as dimples 222) on their surfaces. In some embodiments, the dimples 222 can appear as protrusions when viewed from the channel between the electrochemical cells 210a, 210b, 210c, 210d, 210e and can appear as depressions (or hollowed portions) when viewed from the electrochemical cells 210a, 210b, 210c, 210d, 210e. In some embodiments, the dimples 222 can appear as protrusions when viewed from the channel between the electrochemical cells 210f, 210g, 210h, 210i, 210j and can appear as depressions when viewed from the electrochemical cells 210f, 210g, 210h, 210i, 210j. In some embodiments, the dimples 222 can appear as protrusions the surface facing the fluid flow channel and a substantially flat surface facing the array of electrochemical cells 210a, 210b, 210c, 210d, 210e or the array of electrochemical cells 210f, 210g, 210h, 210i, 210j, respectively. In some embodiments, the dimples 222a can contact the heat transfer plate 220b. In some embodiments, the dimples 222b can contact the heat transfer plate 220a.

In some embodiments, the dimples 222 can provide higher surface area for enhanced heat transfer between the heat transfer plates 220a, 220b (collectively referred to as heat transfer plates 220) and the heat transfer fluid, and/or impede or enhance the rate of fluid flow through the channel between the heat transfer plates 220a, 220b. In some embodiments, the dimples 222 on the surface of the heat transfer plates 220 facing the fluid flow channel cause turbulence in the flow of the fluid through the channel. In some embodiments, the turbulence in the fluid flow enhances the rate of heat transfer between heat transfer plates 220 and the heat transfer fluid.

In some embodiments, the dimples 222 can be arranged uniformly and symmetrically on the heat transfer plates 220a, 220b. In some embodiments, the dimples 222 can be arranged randomly on the heat transfer plates 220a, 220b. In some embodiments, the dimples 222 may have a variety of shapes, height/depths, and spacing between them as described below. In some embodiments, the dimples 222 on the surface of the heat transfer plates 220 can be aligned or staggered to achieve a desired impedance and/or turbulence in the fluid flow path. In some embodiments the arrays of the dimples 222 on the surfaces of heat transfer plates 220a and 220b may be aligned or offset with respect to each other in order to achieve a desired impedance and/or turbulence in the fluid flow path and hence a desired heat transfer rate.

FIG. 2B shows the overlay and spatial orientation of the dimples 222b from the heat transfer plate 220b (not shown in FIG. 2B) with the dimples 222a of the heat transfer plate 220a (not shown in FIG. 2A). In other words, FIG. 2B shows the spacing of the dimples 222a, 222b without showing the heat transfer plates 220 that include dimples 222a, 222b. As shown, the dimples 222a have a triangular base and are arranged in 9 rows and 6 columns, while the dimples 222b have a triangular base and are arranged in 8 rows and 5 columns. Adjacent rows are offset by half the pitch distance between two adjacent columns. As shown, the example plate dimensions are 160 units width and 240 units length. The pitch between adjacent columns of protrusions is 25 units and offset distance between adjacent rows being equal to 12.5 units. One unit in this example is equal to 25.4 microns.

The dimples 222 can induce turbulence in the heat transfer fluid as the heat transfer fluid passes by the dimples 222. The dimples 222 can create local eddies having a velocity greater than a bulk velocity of the heat transfer fluid by a factor of at least about 1.5, at least about 2, at least about 2.5, at least about 3, at least about 3.5, at least about 4, at least about 4.5, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, or at least about 20, inclusive of all values and ranges therebetween.

FIG. 2C shows a 3-dimensional rendering of the heat transfer plate 220a having a rectangular array of dimples 222a. This particular example embodiment depicts a total of 54 dimples in a 9×6 rectangular array of protrusions without any offset between rows or columns. FIG. 2D is an example 3-dimensional rendering of the second heat transfer plate 220b having a rectangular array of dimples 222b to be placed in front of the first heat transfer plate 220a. This particular example embodiment depicts a total of 40 protrusions in an 8×5 rectangular array of protrusions without any offset between rows or columns. As a combination, the two example embodiments of first heat transfer plate 220a and second heat transfer plate 220b illustrate an example embodiment that the dimples on the two plates do not mirror each other. This lack of mirroring can aid in the coupling of these heat transfer plates 220 together and can induce turbulence in the air flow through the channel between the two heat transfer plates 220. In other words, if the dimples 222a do not align with the dimples 222b, the dimples 222a can fit in spaces between the dimples 222b (and vice versa) when the heat transfer plates 220 are brought together.

In some embodiments, the dimples 222 can be arranged on each of the transfer plates in an m×n array of dimples 222. In some embodiments, m and/or n can be about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, or about 50, inclusive of all values and ranges therebetween.

In some embodiments, a horizontal distance dh between the dimples 222 on their respective heat transfer plates 220 can be at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, or at least about 3 cm. In some embodiments, the horizontal distance dh between the dimples 222 on their respective heat transfer plates 220 can be no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced distances are also possible (e.g., at least about 100 μm and no more than about 3 cm or at least about 500 μm and no more than about 5 mm), inclusive of all values and ranges therebetween. In some embodiments, the horizontal distance dh between the dimples 222 on their respective heat transfer plates 220 can be about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm.

In some embodiments, a vertical distance dv between the dimples 222 on their respective heat transfer plates 220 can be at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, or at least about 3 cm. In some embodiments, the vertical distance dv between the dimples 222 on their respective heat transfer plates 220 can be no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced distances are also possible (e.g., at least about 100 μm and no more than about 3 cm or at least about 500 μm and no more than about 5 mm), inclusive of all values and ranges therebetween. In some embodiments, the vertical distance dv between the dimples 222 on their respective heat transfer plates 220 can be about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, or about 3 cm.

In some embodiments, the material of the heat transfer plates 220 may be a metal, alloy, ceramic, composite, polymer or combinations thereof. In some embodiments, the material of the heat transfer plates 220 may include metal-matrix composite, metal-ceramic composites or carbon composites. In some embodiments, the material of the heat transfer plate may include Carbon Steel, Copper, Nickel, Cupro-Nickel (90/10 Cupro-Nickel, 80/20 Cupro-Nickel, 70/30 Cupro-Nickel), Inconel, Incoloy, Admiralty Brass, Stainless Steel (304/L Stainless Steel, 316/L Stainless Steel, 317/L Stainless Steel, 321/L Stainless Steel), Duplex Steel, Alloy 20 (Nickel-Chromium-Molybdenum), Monel 400, Hastelloy B, Hastelloy C, Titanium, Aluminum, Nickel 200, Al-6XN Superaustenitic Stainless Steel, Brass (70Cu-30 Zn), Aluminum Brass (76Cu-22Zn-2Al), Red Brass (85Cu-15Zn), Carbon-moly (0.5Mo), Chrome-moly steel, Lead, Zinc, Tungsten, Silicon Carbide, Aluminum Nitride, Graphite, Polypropylene or combinations thereof.

In some embodiments, the material of the heat transfer plates 220 may have a thermal conductivity of at least about 0.1 W/m-K, at least about 0.5 W/m-K, 1 W/m-K, at least about 5 W/m-K, 10 W/m-K, at least about 50 W/m-K, 100 W/m-K, at least about 500 W/m-K, at least about 1,000 W/m-K, or at least about 2,500 W/m-K. In some embodiments, the material of the heat transfer plates 220 may have a thermal conductivity of no more than about 5,000 W/m-K, no more than about 2,500 W/m-K, no more than about 1,000 W/m-K, no more than about 500 W/m-K, no more than about 100 W/m-K, no more than about 50 W/m-K, no more than about 10 W/m-K, no more than about 5 W/m-K, no more than about 1 W/m-K, or no more than about 0.5 W/m-K.

In some embodiments, the dimples 222 on the surface of the heat transfer plates 220 may be fabricated from a material having different thermal conductivity than rest of the heat transfer plate 220. In some embodiments, the material of the heat transfer plates 220 is resistant to the corrosion that may be caused by the any potential leakage of compounds from the electrochemical cells 210 or the heat transfer fluid. In some embodiments, the material of the heat transfer plates 220 are resistant to abrasion that may be caused by the flow of the heat transfer fluid. In some embodiments, the heat transfer plates 220 may have a coating having a thermal conductivity different from rest of the heat transfer plates 220.

FIG. 2E is an illustration of a single dimple 222a in the shape of a polyhedron. The shape of the polyhedron defining the dimple 222a is defined by the shape of the base coplanar with the plane of the heat transfer plate, a height defining the vertical distance of the farthest tip of the polyhedron from the base of the polyhedron, a specified number of the sides, angles of the sides with respect to the base, shape of the polyhedron sides, shape of the edges of the polyhedron and shape of the corners of the polyhedron. As shown, the polyhedron has a triangular distal surface and three rectangular surfaces adjoining the triangular surface to the surface of the heat transfer plate 220a. In some embodiments, each of the corners of the polyhedron can protrude the same or approximately the same distance from the surface of the heat transfer plate 220a. In some embodiments, each of the corners of the polyhedron can protrude a different distance from the surface of the heat transfer plate 220a.

In some embodiments, the base of the polyhedron defining the dimple 222a may be a triangle, a square, a rectangle, parallelogram, rhombus, diamond shape or another polygon. In some embodiments, the base of the polyhedron may be a polygon having number of sides (e.g., about 3, about 4, about 5, about 6, about 7, about 8, about 9, about 10, about 11, about 12, about 13, about 14, about 15, about 16, about 17, about 18, about 19, or about 20, inclusive of all values and ranges therebetween). In some embodiments, the base of the polyhedron may be a regular polygon or an irregular polygon. In some embodiments, the base of the dimple 222a can have a circular, elliptical, oval, semi-circle, semi-elliptical, pointed oval, or other rounded shape.

In some embodiments the height of the polyhedron defining the dimple 222a may be in the range between about 10 μm and about 10 mm. In some embodiments each of the dimples 222 can have the same height. In some embodiments, the dimples 222 can have varying or non-uniform heights.

In some embodiments, the polyhedron defining the dimple 222a may have at least about 4 surfaces including the base. In some embodiments, the polyhedron can have more than 4 surfaces. In some embodiments, the polyhedron has number of surfaces between 3 and 20. In some embodiments, different dimples 222 in an array have different number of surfaces. In some embodiments, the polyhedron defining the dimple 222a can be an irregular polyhedron. In some embodiments, the angle between the surfaces of polyhedron can be acute. In some embodiments, the angles between the surfaces of the polyhedron can be obtuse. In some embodiments, the surfaces of the polyhedron can be arranged in an “oblique” manner such that at least one of the surfaces of the polyhedron are accessible to the flow of air in the channel between two heat transfer plates 220. In other words, one or more surfaces of the polyhedron can be visible from the x-y plane, the x-z plane, and the y-z plane. In some embodiments, the surfaces of the polyhedron may have an acute angle with the respect to the base of the polyhedron. In some embodiments, at least one of the sides of the polyhedron may have an obtuse angle with respect to the base of the polyhedron. In some embodiments, the surfaces of the polyhedron are twisted or curved with respect to each other. In some embodiments, at least one of the sides of the polyhedron can be non-planar. In some embodiments, the shape and height of the polyhedron are designed to induce maximum turbulence in the flow of the heat transfer fluid in the channel between the heat transfer plates 220.

In some embodiments, the edges of the surfaces of the polyhedron may be sharp edges. In some embodiments, at least one of the edges of the surfaces of the polyhedron can be filleted. In some embodiments, at least one of the edges of the surfaces of the polyhedron can be chamfered. In some embodiments, at least one of the edges of the surfaces of the polyhedron can be rounded. In some embodiments, the corners of the polyhedron may be sharp corners. In some embodiments, at least one the corners of the polyhedron may be filleted. In some embodiments, at least one the corners of the polyhedron may be chamfered. In some embodiments, at least one the corners of the polyhedron may be rounded. In some embodiments, the edges of the polyhedron may be shaped to induce maximum turbulence in the flow of air through the channel between two heat transfer plates.

FIG. 2F shows an example embodiment of a 3-D rendering of a polyhedron-shaped dimple 222a. As shown, one of the faces of the polyhedron is an oblique face. Also shown in FIG. 2E are the filleted edges and corners. FIG. 2F shows the underside of a 3-D rendering of a polyhedron defining the dimple 222a, such that the dimple 222a appears as a depression.

FIG. 2G shows an example embodiment of a 3-D rendering of the dimple 222b in the shape of a polyhedron. As shown, the polyhedron has three sides with one of the sides being an oblique side. The edges of different sides of the polyhedrom have their lengths shown as s1 and s2 and as thicknesses t1, t2 and t3. As seen from FIG. 2G, for one particular side of the polyhedron, the length of the opposite edges s1 and s2 may be unequal. Similarly, the length of opposite edges may have different thicknesses t1 and t2.

In some embodiments, t1, t2, and/or t3 can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, or at least about 4 mm, at least about 5 mm, at least about 6 mm, at least about 7 mm, at least about 7 mm, at least about 9 mm, or at least about 10 mm. In some embodiments, t1, t2, and/or t3 can be no more than about 10 mm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced lengths of t1, t2, and/or t3 are also possible (e.g., at least about 10 μm and no more than about 10 mm or at least about 100 μm and no more than about 1 mm), inclusive of all values and ranges therebetween. In some embodiments, t1, t2, and/or t3 can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 10 mm.

In some embodiments, s1 and/or s2 can be at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, or at least about 3 cm. In some embodiments, s1 and/or s2 can be no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, or no more than about 60 μm. Combinations of the above-referenced lengths of s1 and/or s2 are also possible (e.g., at least about 50 μm and no more than about 3 cm or at least about 1 mm and no more than about 5 mm), inclusive of all values and ranges therebetween. In some embodiments, s1 and/or s2 can be about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, or about 3 cm.

As seen in FIG. 2G, the edges between two sides of the polyhedron are filleted and the corners of the polyhedron are rounded. FIG. 2H shows a different view of the 3-D rendering of the polyhedron defining the protrusion 222b. As seen in the figure, filleted edges, rounded corners and oblique faces are present in the protrusion.

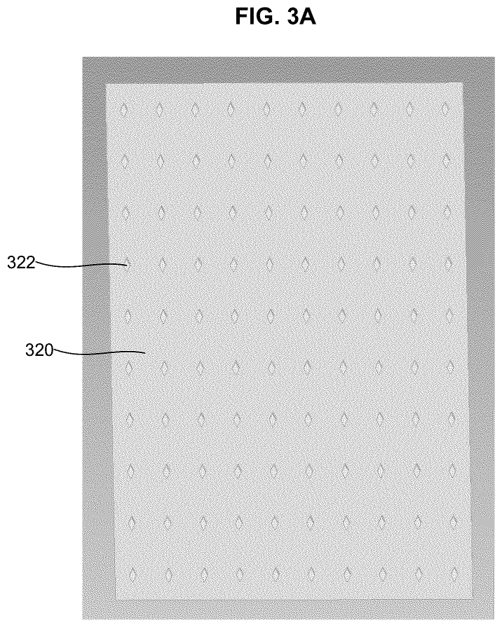

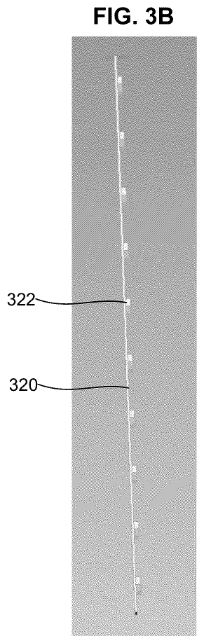

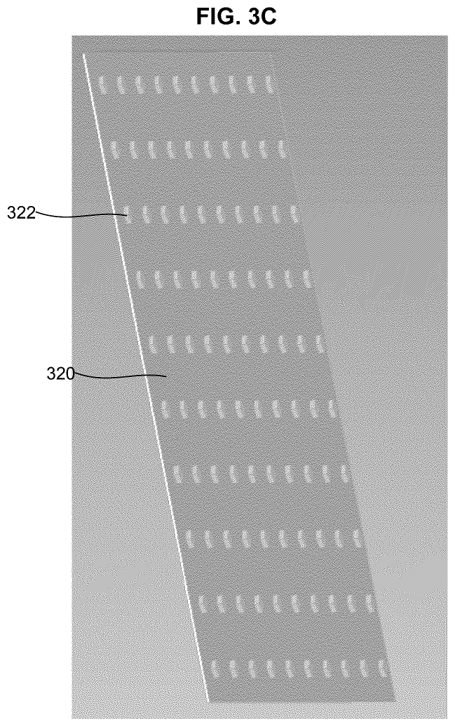

FIGS. 3A-3B show an example embodiment of a heat transfer plate 320 having an array of dimples 322 arranged in a rectangular shape. As shown, the base of the polyhedra defining the dimples 322 are diamond shaped. The 10×10 rectangular array has a different horizontal pitch compared the vertical pitch and there is no offset between adjacent rows or columns. FIG. 3A shows a top view of the heat transfer plate 320 and FIG. 3B shows a side view of the example embodiment of the heat transfer plate 320. As seen in FIGS. 3A-3B, the protrusions have a vertical height with respect to the heat transfer plate.

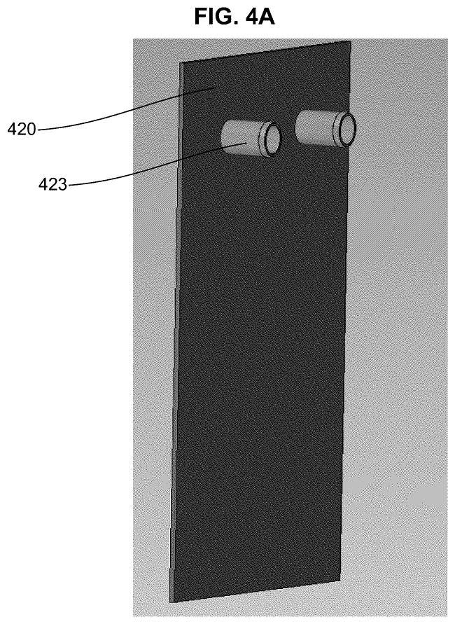

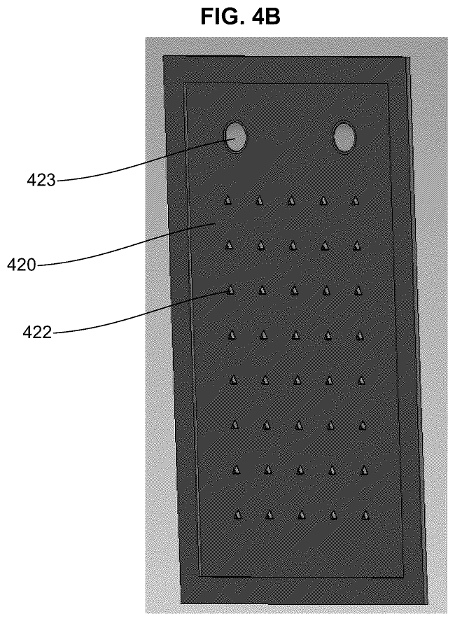

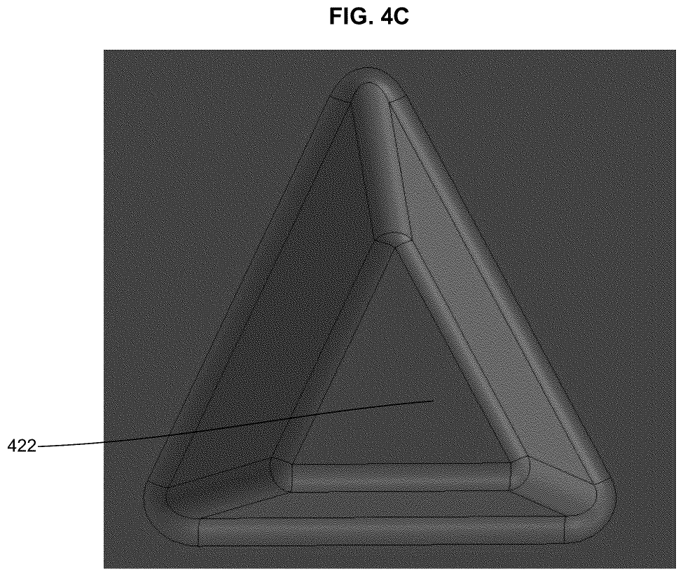

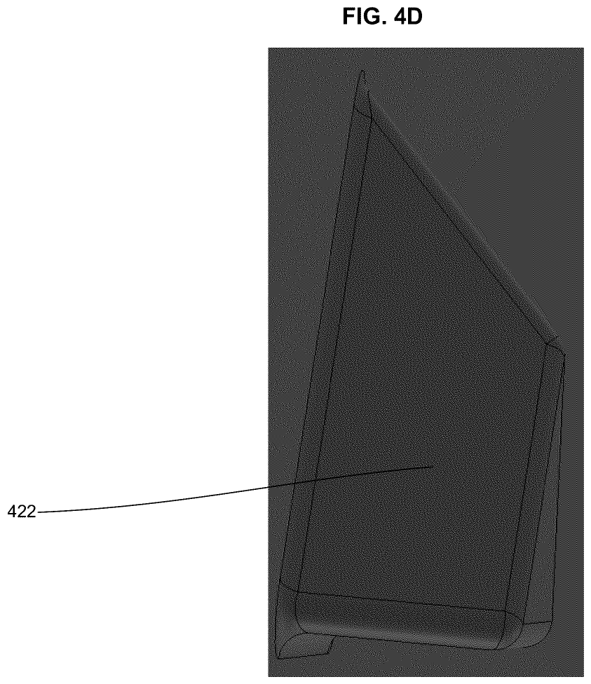

FIGS. 4A-4D show an example embodiment of a heat transfer plate 420, including dimples 422 and nozzles 423. In some embodiments, the heat transfer plate 420 and the dimples 422 can be the same or substantially similar to the heat transfer plate 220 and the dimples 222, as described above with reference to FIGS. 2A-2H. Thus, certain aspects of the heat transfer plate 420 and the dimples 422 are not described in greater detail herein.

FIG. 4A shows an auxiliary view of the heat transfer plate 420 with the nozzles 423 inserted into holes in the heat transfer plate 420. The side of the heat transfer plate 420 shown in FIG. 4A contacts the electrochemical cells (not shown). FIG. 4B shows the heat transfer plate 420 from the opposite side from FIG. 4A, with the dimples 422 visible. The side of the heat transfer plate 420 shown in FIG. 4B is adjacent to a channel formed between adjacent heat transfer plates, through which a heat transfer fluid flows. In use, heat transfer fluid flows into the nozzles 423 and into the channel between adjacent heat transfer plates 420. The heat transfer fluid then interacts with the dimples 422 to become disturbed and/or turbulent, enhancing heat transfer out of the electrochemical cells.

FIGS. 4C-4D show one of the dimples 422 from different perspectives. FIG. 4C shows a plan view of the dimple 422, while FIG. 4D shows a side view of the dimple 422. As shown, the dimple 422 has a polyhedron shape, with a base having a triangle shape and a top surface having a smaller triangle shape. The top surface is connected to the base via a first side and a second side oriented approximately perpendicular to the surface of the heat transfer plate 420 and a third side forming an angle of approximately 450 with the surface of the heat transfer plate 420. In some embodiments, the third side can form an angle of about 20°, about 25°, about 30°, about 35°, about 40°, about 45°, about 50°, about 55°, about 60°, about 65°, or about 700 with the surface of the heat transfer plate 420, inclusive of all values and ranges therebetween.

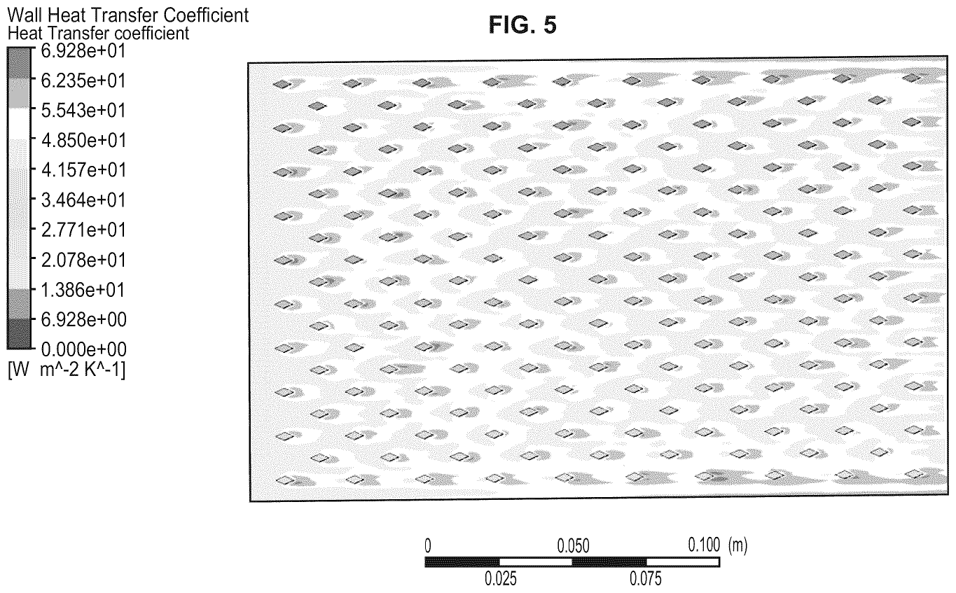

FIG. 5 shows an example embodiment of a heat transfer plate having diamond shaped protrusions simulated for heat transfer coefficient under operational conditions. As shown, the values of heat transfer coefficient for different areas of the heat transfer plate are in the range between about 30 W/m²-K and about 70 W/m²-K. Higher values of heat transfer coefficient are achieved in the regions around the protrusions. This may be attributed to the increased turbulence in the air flow in areas around the protrusions leading to better heat transfer.

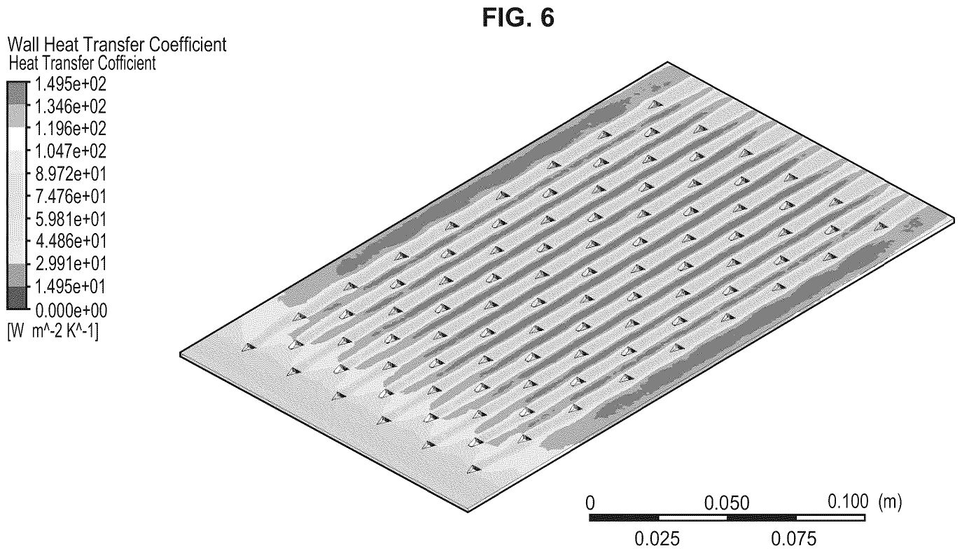

FIG. 6 shows an example embodiment of a heat transfer plate having tetrahedral shaped protrusions with triangular base simulated for heat transfer coefficient under operational conditions. Here the protrusions are arranged in such a manner that the protrusions in adjacent rows are separated by distance equal to the half pitch between two adjacent columns. As shown, the values of heat transfer coefficient for different areas of the heat transfer plate are in the range between about 45 W/m²-K and about 150 W/m²-K. Higher values of heat transfer coefficient (about 100 W/m²-K to about 150 W/m²-K) are achieved in the regions between two columns in substantially columnar bands. Without intending to be bound by any theory, this increase in heat transfer coefficient in columnar bands may be attributed to the increased turbulence in the air flow in these areas.

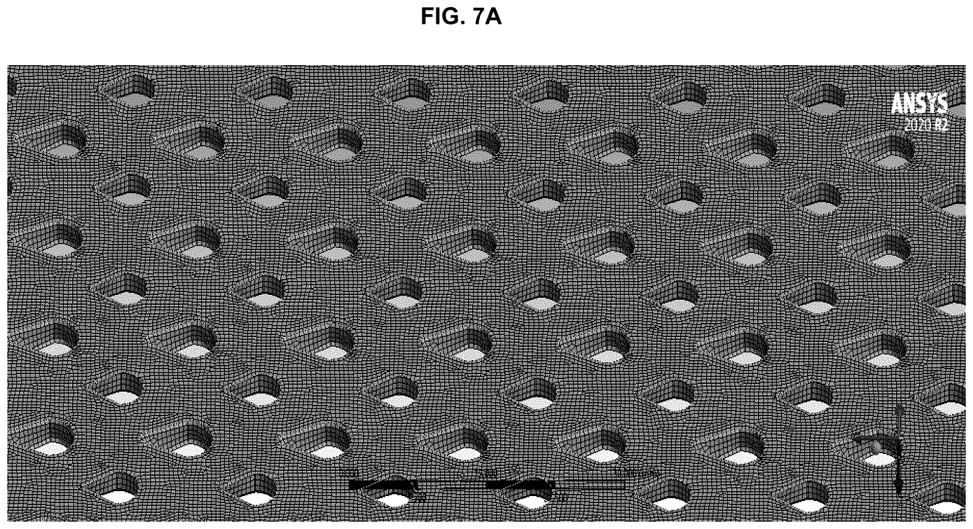

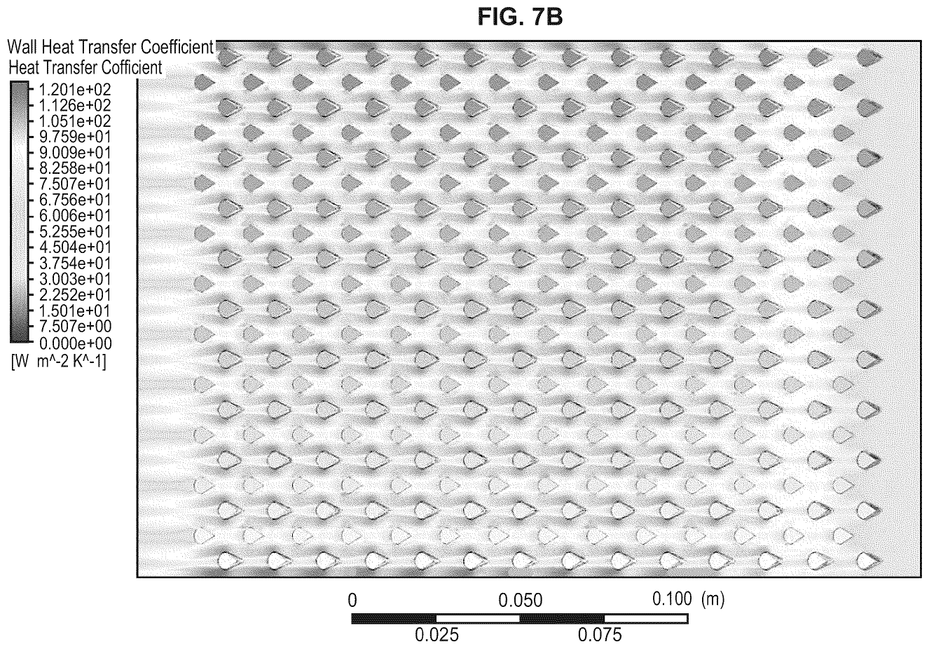

FIG. 7A shows negative space between two adjacent heat transfer plates with teardrop-shaped dimples. The dimples appearing larger are from adjacent heat transfer plates, while the dimples appearing smaller are from opposite heat transfer plates. In other words, the bases of the dimples are larger than the top surfaces of the dimples. FIG. 7B shows simulated heat transfer coefficients of the heat transfer plates under operational conditions. As shown, the values of heat transfer coefficient for different areas of the heat transfer plates are in the range between about 50 W/m²-K and about 120 W/m²-K. Heat transfer is highest in the regions between the dimples.

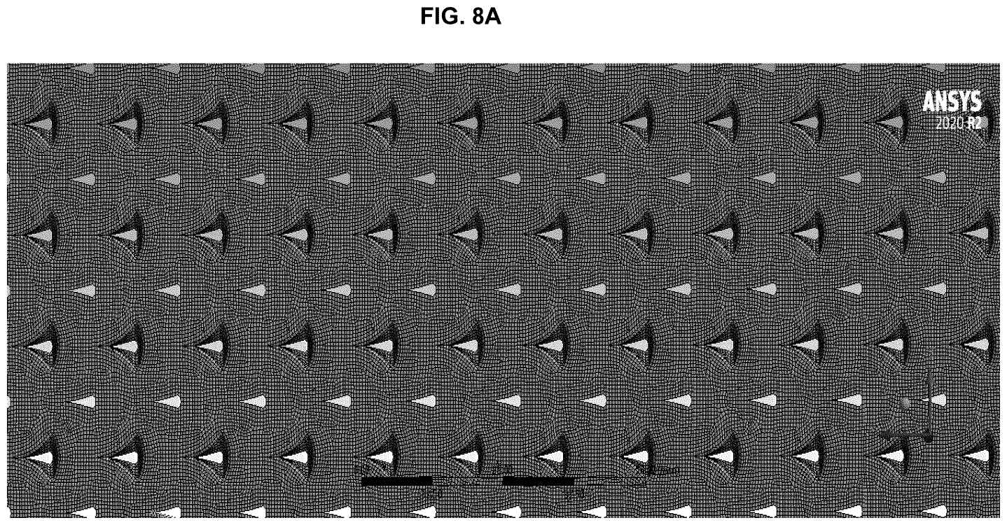

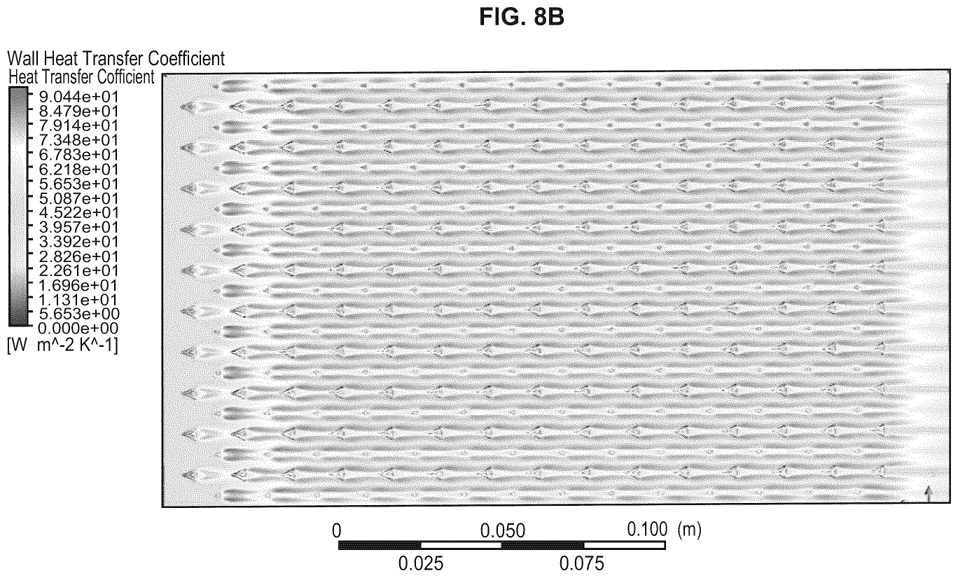

FIG. 8A shows negative space between two adjacent heat transfer plates with rounded tetrahedron-shaped dimples. The dimples have a broad, triangular base with rounded sides, and become smaller toward the top surface. FIG. 8B shows simulated heat transfer coefficients of the heat transfer plates under operational conditions. As shown, the values of heat transfer coefficient for different areas of the heat transfer plates are in the range between about 45 W/m²-K and about 90 W/m²-K. Heat transfer is highest in the regions between the dimples and heat transfer coefficients are more uniform heat transfer coefficients throughout the heat transfer plates in FIGS. 8A-8B, compared to FIGS. 5-7B.

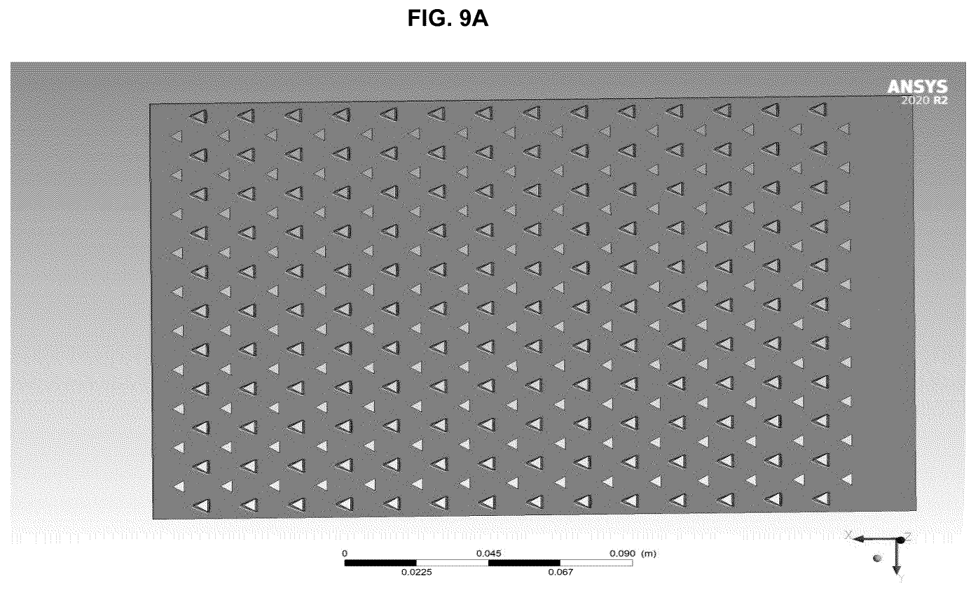

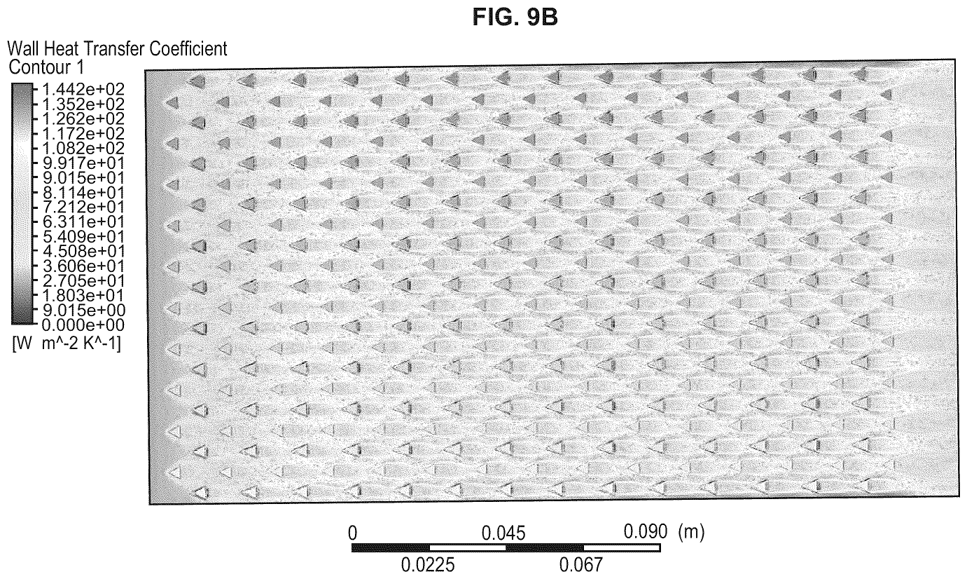

FIG. 9A shows negative space between two adjacent heat transfer plates with rounded tetrahedron-shaped dimples. The dimples have a triangular base with rounded sides and a slightly smaller top surface. FIG. 9B shows simulated heat transfer coefficients of the heat transfer plates under operational conditions. As shown, the values of heat transfer coefficient for different areas of the heat transfer plates are in the range between about 70 W/m²-K and about 130 W/m²-K. Heat transfer is highest in the regions between the dimples on the right side of the plot (i.e., later in the flow path of the heat transfer fluid).

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell system, comprising:
a first electrochemical cell;
a second electrochemical cell;
a first planar sheet contacting the first electrochemical cell, the first planar sheet including a first plurality of dimples; and
a second planar sheet contacting the second electrochemical cell, the second planar sheet extending parallel to the first planar sheet, the second planar sheet separated from the first planar sheet by a separation distance, the second planar sheet including a second plurality of dimples;
wherein the first plurality of dimples and the second plurality of dimples are both configured to induce turbulence in an air stream flowing parallel to the first planar sheet and the second planar sheet.

2. The electrochemical cell system of claim 1, further comprising:
a first additional plurality of electrochemical cells contacting the first planar sheet; and
a second additional plurality of electrochemical cells contacting the second planar sheet.

3. The electrochemical cell system of claim 1, wherein the first plurality of dimples protrude outward from the first planar sheet and the second plurality of dimples protrude outward from the second planar sheet.

4. The electrochemical cell system of claim 3, wherein distal surfaces of the first plurality of dimples have a triangular shape.

5. The electrochemical cell system of claim 4, wherein each of the distal surfaces adjoins three adjacent surfaces, the three adjacent surfaces contacting a base portion of the first planar sheet.

6. The electrochemical cell system of claim 5, wherein each of the three adjacent surfaces have a rectangular shape.

7. The electrochemical cell system of claim 6, wherein adjoinment between the distal surface and the three adjacent surfaces includes a filleted surface.

8. The electrochemical cell system of claim 6, wherein at least one of the three adjacent surfaces is an oblique surface.

9. The electrochemical cell system of claim 1, wherein the second plurality of dimples are configured to contact the first planar sheet in spaces between the first plurality of dimples.

10. The electrochemical cell system of claim 4, wherein each of the distal surfaces has a first corner that protrudes a first distance from the first planar sheet, a second corner that protrudes a second distance from the first planar sheet, and a third corner that protrudes a third distance from the first planar sheet, the first distance, the second distance, and the third distance different from each other.

11. A planar sheet configured to be placed between electrochemical cells to improve heat dispersion from the electrochemical cells, the planar sheet including:
a base surface; and
a plurality of dimples protruding outward from the base surface, the plurality of dimples each including:
a distal surface, the distal surface having a triangular shape;
three adjacent surfaces adjoining the base surface and the distal surface; and
filleted joints adjoining the adjacent surfaces and the distal surface.

12. The planar sheet of claim 11, wherein the plurality of dimples include a hollowed area opposite the distal surface.

13. The planar sheet of claim 11, wherein at least one of the three adjacent surfaces is an oblique surface.

14. The planar sheet of claim 11, wherein the plurality of dimples are configured to induce turbulence of an air stream flowing along the planar sheet, creating local eddies having a velocity greater than a bulk velocity of the air stream by a factor of at least about 5.

15. The planar sheet of claim 11, wherein the plurality of dimples are configured to induce turbulence of an air stream flowing along the planar sheet, creating local eddies having a velocity greater than a bulk velocity of the air stream by a factor of at least about 10.

16. An apparatus, comprising:
a first planar sheet including a first base surface and a first plurality of dimples extending from the first base surface; and
a second planar sheet including a second base surface and a second plurality of dimples extending from the second base surface,
wherein the first planar sheet and the second planar sheet are configured to be placed together such that the second plurality of dimples occupy void areas between the first plurality of dimples while the first base surface faces the second base surface.

17. The apparatus of claim 16, wherein each of the first plurality of dimples includes:
a distal surface, the distal surface having a triangular shape;
three adjacent surfaces adjoining the first base surface and the distal surface; and
filleted joints adjoining the adjacent surfaces and the distal surface.

18. The planar sheet of claim 17, wherein at least one of the three adjacent surfaces is an oblique surface.

19. The electrochemical cell system of claim 17, wherein adjoinment between the distal surface and the three adjacent surfaces includes a filleted surface.

20. The apparatus of claim 16, further comprising:
a first electrochemical cell disposed on the first planar sheet opposite the first base surface; and
a second electrochemical cell disposed on the second planar sheet opposite the second base surface.

21. The apparatus of claim 16, wherein the first plurality of dimples are configured to induce turbulence of an air stream flowing along the first planar sheet, creating local eddies having a velocity greater than a bulk velocity of the air stream by a factor of at least about 5.

22. The apparatus of claim 16, wherein the first plurality of dimples are configured to induce turbulence of an air stream flowing along the first planar sheet, creating local eddies having a velocity greater than a bulk velocity of the air stream by a factor of at least about 10.
